(19) United States
(12) Patent Application Publication
(10) Pub. No.: US 2004/0018828 A1
(43) Pub. Date: Jan. 29, 2004

(54) System and method for providing a status to mobile device pre-paid subscriptions

(76) Inventor: Michael H. Adler, Westfield, IN (US)

Correspondence Address: JOSEPH S. TRIPOLI, THOMSON MULTIMEDIA LICENSING INC., 2 INDEPENDENCE WAY, P.O. Box 5312, Princeton, NJ, 08543-5312, US

(21) Appl. No.: 10/205,193

(22) Filed: Jul. 25, 2002

(51) Int. Cl. H04M 11/00

(52) U.S. Cl. 455/405; 455/406

(57) ABSTRACT

A method for providing a status to a device comprising establishing a connection between the device and a service provider, and verifying a device identification. The method further comprises determining a contract corresponding to the device, and sending a status to the device, wherein the status indicates a time unit remaining under the contract for a predetermined time period.

### BACKGROUND OF THE INVENTION

1. Field of the Invention

The present invention relates to pre-paid subscriptions, and more particularly to a method for providing a status to a mobile device.

2. Discussion of Related Art

Subscription based mobile devices are becoming more prevalent as the devices become more feature rich. For example, a personal digital assistant having wireless communication features enabling connections to the Internet. These mobile devices typically have a monthly subscription to an Internet service provider or portal.

Cellular telephones are typically subscription based devices that include a set number of pre-paid minutes. Some cellular telephones include user timers. The user timer can be reset. The user timer can be, for example, a cumulative time that allows a user to track how many minutes they have used since they last reset the timer. However, the user must remember to re-set this timer each month based on the billing cycle for their cellular telephone contract.

Therefore, a need exists for a system and method for providing a status to a mobile device.

### SUMMARY OF THE INVENTION

A method for providing a status to a device comprises establishing a connection between the device and a service provider, verifying a device identification, determining a contract corresponding to the device, and sending a status to the device, wherein the status indicates a time unit remaining under the contract for a predetermined time period.

### BRIEF DESCRIPTION OF THE DRAWINGS

Preferred embodiments of the present invention will be described below in more detail, with reference to the accompanying drawings:

FIG. 1 is a flow chart of a method for updating a status of a mobile device according to an embodiment of the present invention; and

FIG. 2 is a diagram of a system comprising mobile devices adapted to receive status information according to an embodiment of the present invention.

### DETAILED DESCRIPTION

According to an embodiment of the present invention, a system and method provides a remaining units counter, automatically set by a service provider, for example, a cellular telephone service provider or Internet service provider, at the beginning of each billing cycle. The remaining units counter can be updated periodically. Thus, a user can readily determine the number of units remaining, and whether penalty charges will be incurred for excess units used. The units can be time units.

It is to be understood that the present invention may be implemented in various forms of hardware, software, firmware, special purpose processors, or a combination thereof. In one embodiment, the present invention may be implemented in software as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and micro instruction code. The various processes and functions described herein may either be part of the micro instruction code or part of the application program (or a combination thereof) which is executed via the operating system. In addition, various other peripheral devices may be connected to the computer platform such as an additional data storage device and a printing device.

It is to be further understood that, because some of the constituent system components and method steps depicted in the accompanying figures may be implemented in software, the actual connections between the system components (or the process steps) may differ depending upon the manner in which the present invention is programmed. Given the teachings of the present invention provided herein, one of ordinary skill in the related art will be able to contemplate these and similar implementations or configurations of the present invention.

A method according to an embodiment of the present invention comprises, receiving a client's request for a connection, e.g., a cellular telephone call, at a service provider. The service provider determines a number of remaining minutes corresponding to the client's account, wherein the client is a subscriber to a service. The service provider sends the remaining minutes information back to the client. The remaining minutes information can be stored by the client in a memory, for example, flash memory. Upon terminating a call, the remaining minutes information can be added to an elapsed time of the call. The result of the addition can be stored as contract minutes remaining. By storing remaining minutes at call initiation, and adding elapsed time at call termination, true contract minutes remaining can be tracked by the client.

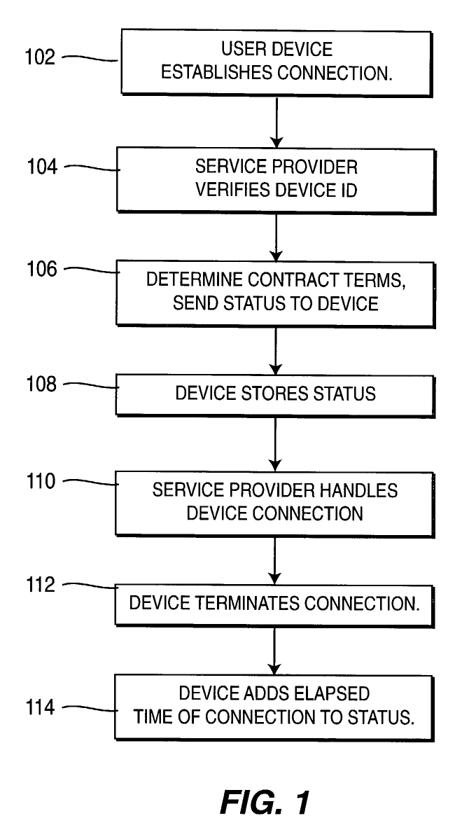

Referring to FIG. 1, when a user device connects to a service provider 102 the service provider verifies a device identification 104. The service provider determines the terms of a contract with the device owners and sends a status to the device 106. The device stores the status 108. The service provider handles a connection for the device 110, and when the device terminates the connection 112 the device adds an elapsed time of the connection to the status received from the service provider 114.

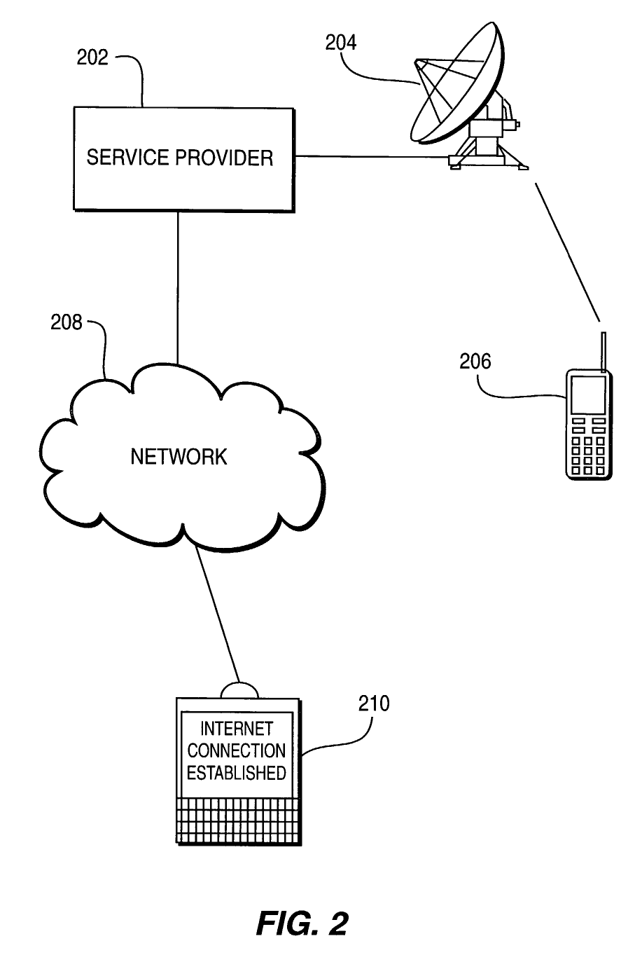

As shown in FIG. 2, a mobile device such as a cellular telephone 206 or a personal digital assistant 210 can request a status from a service provider 202 through a connection. The connection can be established through, for example, a cellular network 204 or a computer network 208. While FIG. 2 illustrates an embodiment of the present invention implementing wireless technology, it should also be understood that the present invention can also be implemented over a network where the device is connected by a physical connection, such as a network interface card.

Having described embodiments for a method for providing a status to a mobile device, it is noted that modifications and variations can be made by persons skilled in the art in light of the above teachings. It is therefore to be understood that changes may be made in the particular embodiments of the invention disclosed which are within the scope and spirit of the invention as defined by the appended claims. Having thus described the invention with the details and particularity required by the patent laws, what is claimed and desired protected by Letters Patent is set forth in the appended claims.

What is claimed is:

1. In a mobile communication transceiver,
a register for storing device identification data for transmission to a network service provider;
a memory for storing an updated remaining time value from the network service provider indicative of remaining communication time available to the user at a prescribed billing rate, the updated remaining time value overwriting a previous remaining time value stored n the memory;
a display for displaying the updated remaining time value.

2. The method of claim 1, wherein the network service provider is an Internet servce provider.

3. The method of claim 1, wherein the communication comprises telephone use.

4. The method of claim 1, wherein the communication comprises data communications.

5. A method for providing status information to a mobile communication device indicative of remaining communication time available to the user at a prescribed billing rate, comprising the steps of:
receiving a request in a communications network from the user requesting an update of the remaining communication time available to that user;
verifying the user making the request;
determining for the user the remaining communication time available that is currently available; and
providing to the mobile communication device an updated value for the remaining communication time available.

6. The method of claim 5, further comprising the step of storing the status in a memory of the device.

7. The method of claim 5, further comprising the step of handling a connection between the device and the service provider.

8. The method of claim 7, wherein the connection enables Internet access.

9. The method of claim 7, wherein the connection enables telephony.

10. A method for obtaining providing status information for a mobile communication device indicative of remaining communication time available to the user at a prescribed billing rate, comprising the steps of:
transmitting a request to a communications network service provider from for update of the remaining communication time available to that user;
providing verification information identifying the user making the request; and
receiving from the network communications service provider communication device an updated value for the remaining communication time available.

11. The method of claim 10, further comprising the step of storing the status in a memory of the communication device.

13. The method of claim 10, further comprising the step of handling a connection between the communication device and the service provider.

14. The method of claim 12, wherein the connection enables Internet access.

15. The method of claim 12, wherein the connection enables telephony.
